(19) United States
(12) Patent Application Publication
(10) Pub. No.: US 2013/0194569 A1
(43) Pub. Date: Aug. 1, 2013

(54) SUBSTRATE INSPECTION METHOD

(71) Applicants: Hyun-ki Lee, Daegu (KR); Dal-An Kwon, Gunpo-si (KR); Jeong-Yul Jeon, Seongnam-si (KR)

(72) Inventors: Hyun-ki Lee, Daegu (KR); Dal-An Kwon, Gunpo-si (KR); Jeong-Yul Jeon, Seongnam-si (KR)

(73) Assignee: KOH YOUNG TECHNOLOGY INC., Seoul (KR)

(21) Appl. No.: 13/879,597

(22) PCT Filed: Oct. 13, 2011
(86) PCT No.: PCT/KR2011/007630

§ 371 Date: Apr. 15, 2013

(30) Foreign Application Priority Data
Oct. 14, 2010 (KR) 10-2010-0100406

(51) Int. Cl. G01N 21/93

(52) U.S. Cl. CPC G01N 21/93
USPC 356/237.4

(57) ABSTRACT

A substrate inspection apparatus for inspecting a substrate, on which a measurement object is formed, is shown. The substrate inspection method includes measuring a substrate, on which a measurement object is formed, generating a plane equation of the substrate, and acquiring a region of the measurement object formed on the substrate. After, by considering a height of measurement object a region of the measurement object is converted into a substrate plane by plane equation,. Then, the measurement object is inspected based on a region of the measurement object converted into a substrate plane by plane equation and a region of the measurement object by reference data. Therefore, an offset value of a measurement object is acquired according to a tilted pose of the substrate, and a distortion of measurement data is compensated by using the offset value, to improve a measurement credibility of a measurement object.

### TECHNICAL FIELD

The present invention relates to a method of inspecting a substrate, and more particularly to a method of inspecting a substrate capable of correcting a distortion of a measurement data under various pose of a measurement object that is formed on a substrate, to improve a measurement credibility.

### BACKGROUND ART

Generally, an electronic device has a substrate to control the operation of the electronic device. Especially, an electronic device having a substrate that has a central processing unit (CPU) to central-control the electronic device. The CPU is an important part of the electronic device, so to check the credibility of the CPU, an inspection test should be performed to test whether the CPU is properly on the substrate.

Recently, in order to measure a three-dimensional shape of a substrate, on which a measurement object is formed, a substrate inspection apparatus having at least one projection part that includes an illuminating-source and a lattice-device to provide a pattern-light towards a measurement object and, an image-capture part that image-captures a pattern-image by providing a pattern-light, is used to inspect a substrate having a measurement object.

However, previously only two-dimensional measurement not considering a tilted pose of a substrate were measured, when a substrate, on which a measurement object is formed, is a little tilted to an image plane of an image-capture part, a distortion of a measurement data such as a position, size, height, etc., of the measurement object may occur.

### DETAILED DESCRIPTION OF THE INVENTION

### Objects of the Invention

Therefore, the present invention is to solve the problem, and the object of the present invention is to provide a method of inspecting a substrate capable of correcting a distortion of a measurement data according to a pose of a substrate, on which a measurement object is formed, to improve a credibility of a measurement data.

### Technical Solution

In an exemplary embodiment, a method of inspecting a substrate includes generating a plane equation of a substrate by measuring the substrate, on which a measurement object is formed, with an image-capture part, acquiring a region of the measurement object formed on the measured substrate, converting the region of the measurement object into a substrate plane by the plane equation, by considering a height of the measurement object, and inspecting the measurement object based on the region of the measurement object converted into the substrate plane by the plane equation and a region of the measurement object by a reference data.

For example, generating a plane equation may include generating the plane equation by measuring a distance between an indication marks that are formed on the substrate. For example, generating a plane equation may include generating the plane equation by measuring the substrate with a laser. For example, generating a plane equation may include generating the plane equation by measuring the substrate with a moire measurement technique.

Acquiring a region of the measurement object may include acquiring four straight lines corresponding to four sides of the measurement object so that two facing sides of the four sides are maintained parallel.

Converting the region of the measurement object into the substrate plane by the plane equation by considering a height of the measurement object may include converting the region of the measurement object into the substrate plane by the plane equation by acquiring one point on the substrate plane with regard to at least one location of the region of the measurement object, wherein a vertical distance from a point on a straight line connecting the image plane of the image-capture part and the substrate plane by the plane equation to the one point on the substrate plane corresponds to the height of the measurement object

The method of inspecting a substrate may further include matching a middle of a line that connects the indication mark of the substrate plane by the reference data with a middle of a line that connects the indication mark of the substrate plane by the plane equation, and matching the line that connects the indication mark of the substrate plane by the reference data with the line that connects the indication mark of the substrate plane by the plane equation.

The inspection of the measurement object measures at least one of four offsets, the four offsets may include a first offset corresponding to an offset in an X direction between a center of the measurement object by the reference data and a center of the measurement object by the plane equation, a second offset corresponding to an offset in a Y direction between a center of the measurement object by the reference data a center of the measurement object by the plane equation, a third offset corresponding to a tilted angle of the measurement object by the plane equation to the measurement object by the reference data, and a fourth offset corresponding to a distance between four corners of the measurement object by the reference data and four corners of the measurement object by the plane equation.

The substrate is measured by using an image-capture part having a telecentric lens. Before measuring the substrate on which a measurement object is formed, correcting the reference plane that is a reference of a height measuring is further included.

In other exemplary embodiment, a method of inspecting a substrate includes generating a plane equation of a substrate by measuring the substrate, on which a measurement object is formed, acquiring a region of the measurement object formed on the substrate, converting the region of the measurement object into a substrate plane by the plane equation, matching the substrate plane by the plane equation with a substrate plane by a reference data, and inspecting the measurement object based on a region of the measurement object by the reference data and the region of the measurement object converted into the substrate plane by the plane equation.

In another exemplary embodiment, a method of inspecting a substrate includes generating a plane equation of a substrate for each measurement region, by dividing an entire portion of the substrate, on which a measurement object is formed, into at least two measurement regions and measuring each measurement region, with an image-capture part, acquiring a region of the measured measurement object of each measurement region, converting the acquired region of the measured measurement object of each measurement region into a substrate plane by the plane equation, matching a plurality of substrate planes by the plane equation acquired from a plurality of measurement regions with each other to an identical substrate plane, and inspecting the measurement object based on the region of the measurement object by the substrate plane matched to the identical plane and a region of the measurement object by a reference data.

Matching a plurality of substrate planes by the plane equation acquired from a plurality of measurement regions with each other to an identical substrate plane may include matching the substrate planes based on at least one of a common region of the measurement regions and the region of the measurement object.

Converting the acquired region of the measured measurement object of each measurement region into a substrate plane by the plane equation may include converting the acquired region of the measured measurement object of each measurement region into a substrate plane by the plane equation, by considering a height of the measurement object.

### Advantageous Effects

According to a method of inspecting a substrate, an offset value of a measurement object is acquired according to a tilted pose of the substrate, on which the measurement object is formed, and a distortion of a measurement data is compensated by using the offset value, to improve a measurement credibility of a measurement object.

In addition, when acquiring coordinate of corner and center of measurement object, two straight lines facing each other of the four straight lines corresponding to four sides of the measurement object are maintained to be parallel, in order to acquire an accurate coordinate of corner and center of measurement object.

In addition, when a region of measurement object is converted into a substrate plane by the measurement data by considering a height of the measurement object, a substrate plane by measurement data and a substrate plane by reference data are identified, to acquire a more accurate offset value of measurement object.

In addition, when a tilted pose of a substrate may not be assumed by use of telecentric lens, tilted pose of a substrate is measured and distortion of the measurement data according to a tilted pose is compensated, to improve credibility of measurement data.

In addition, when a field of view (FOV) of image-capture part may not cover an entire portion of large-size substrate, the large-size substrate is divided into plurality measurement region and each measurement region are measured, substrate planes measured from each measurement region are matched in to one substrate plane based on corner of measurement object, to acquire an accurate offset value of the measurement object according to large-size substrate.

### BRIEF DESCRIPTION OF THE DRAWINGS

FIG. 1 is a block diagram briefly illustrating of an inspection apparatus according to an embodiment of the present invention.

FIG. 2 is a flow chart illustrating a compensation method of a measurement object according to an embodiment of the present invention.

FIG. 3 is a plan view illustrating a substrate, on which a measurement object is formed.

FIG. 4 is a drawing illustrating a substrate plane by a plane equation.

FIG. 5 is a flow chart illustrating a method of acquiring a region of measurement object.

FIG. 6 is a conceptual view illustrating a method of acquiring a region of measurement object.

FIG. 7 is a conceptual view illustrating a process of correcting a region of measurement object into a substrate plane by plane equation.

FIG. 8 is a conceptual view illustrating a process of matching a substrate plane by plane equation and a substrate plane by reference data.

FIG. 9 is a conceptual view illustrating a process of inspecting a measurement object.

FIG. 10 is a flow chart illustrating a correction method of a substrate plane according to an embodiment of the present invention.

FIG. 11 is a conceptual view illustrating a correction method of a substrate plane in FIG. 10.

FIG. 12 is a perspective view illustrating a second specimen in FIG. 10.

FIG. 13 is a flow chart illustrating a method of calibrating an image-capture part in FIG. 1.

FIG. 14 is a perspective view illustrating a calibration substrate.

FIG. 15 is a flow chart illustrating a correction method of a non-spherical lens formed on a substrate inspection apparatus.

FIG. 16 is a conceptual view illustrating a method of correcting a distortion caused by a non-spherical lens.

FIG. 17 is a flow chart illustrating a compensation method of a measurement object according to another embodiment of the present invention.

FIG. 18 is a conceptual view illustrating a process of measuring an offset value of a large size substrate.

### EMBODIMENTS OF THE INVENTION

The invention is described more fully hereinafter with reference to the accompanying drawings, in which exemplary embodiments of the invention are shown.

However, this invention may be embodied in many different forms and should not be construed as limited to the embodiments set forth herein

Numerical terms such as “one”, “two”, etc. may be used as cardinal numbers to indicate various structural elements, however, the structural elements should not be limited by the terms. The terms are only used to distinguish one structural element from another structural element. For example, a first structural element may be named as second structural element if the right is not beyond the scope, the same applies to the second structural element that may be named as the first structural element.

The terms used in the present application are only to explain the specific embodiment and is not intended to limit the present invention. The terms “a”, “an” and “the” mean “one or more” unless expressly specified otherwise. The terms “including”, “comprising”, etc., are to designate features, numbers, processes, structural elements, parts, and combined component of the application, and should be understood that it does not exclude one or more different features, numbers, processes, structural elements, parts, combined component.

If not defined differently, all the terms used herein including technical or scientific terms, may be understood same as a person skilled in the art may understand.

Terms that are used herein are same as the terms defined in a commonly-used dictionary may be understood as same a contextual meaning, if not mentioned clearly, may not be understood as excessively or ideally.

The invention is described more fully hereinafter with reference to the accompanying drawings, in which exemplary embodiments of the invention are shown.

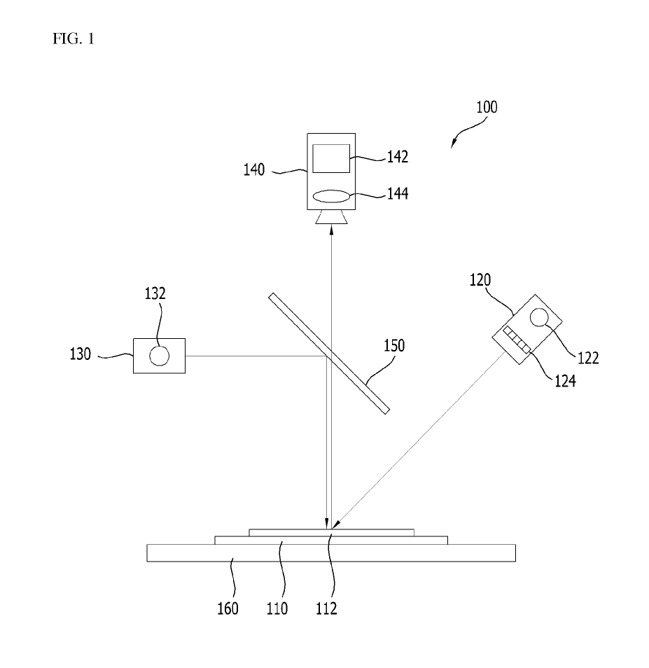

FIG. 1 is a block diagram briefly illustrating of an inspection apparatus according to an embodiment of the present invention.

Referring to FIG. 1, an inspection apparatus 100 according to an exemplary embodiment of the present invention includes a stage 160 that supports or transfers a substrate 110, on which a measurement object 112 is formed, at least one projection part 120 that provides a pattern-light to the substrate 110, an illumination part 130 that provides a light to the substrate 110, an image-capture part 140 that image-captures an image of the substrate 110, and a beam splitter 150 disposed under the image-capture part 140 that reflects one part of a light that is entered and transmits other part of the light.

The projection part 120 provides the substrate 110 with a pattern-light to measure a three-dimensional shape of the measurement object 110 that is formed on the substrate 110. For example, the projection part 120 includes a light source 122 that emits light, and a lattice-element 124 that converts the light from the light source 124 into a pattern-light. In addition, the projection part 120 may include a lattice-transferring device (not shown) that pitch-transfers the lattice-element 124 and a projection lens (not shown) that projects the pattern-light converted by the lattice-element 124 to a measurement object 112. The lattice-element 124 may be transferred by 2π/N by using the lattice transferring device such as a piezoelectric actuator (PZT), for the phase-transition of the pattern-light, where N is a natural number greater than or equal to two. A plurality of projection parts 120 having the above-described structure may be installed around the image-capture part 140, and spaced apart from each other at a regular angle along a circumference direction. For example, four projection parts 120 may be installed around the image-capture part 140, and spaced apart from each other at a 90° along a circumference direction. The projection parts 120 are tilted towards the substrate 110 to have a regular angle, and provides a pattern-light to the substrate 110 from various directions.

The illumination part 130 is installed between the image-capture part 140 and the substrate 110, to provide a light towards the beam splitter 150. The illumination part 130 provides a light to the substrate 110 by using a beam splitter 150 to capture a plane image of the substrate, on which the measurement object 112 is formed. For example, the illumination part 130 includes at least one light source 132 that emits light.

The image-capture part 140 captures a pattern-image of the substrate 110 through the pattern-light that is provided by the projection part 120, and captures a plane image of the substrate 150 through the light provided from the illumination part 130. For example, the image-capture part 140 is installed vertically above from the substrate 150. The image-capture part 140 may include a camera 142 for image-capturing and at least one imaging lens 144 that provides the camera 142 with a light entered from the image-capture part 140. The camera 142 may include a CCD camera or a CMOS camera. For example, the imaging lens 144 may include a telecentric lens that only passes a light that is parallel with the light axis, in order to minimize an image distortion caused by a Z axis.

The beam splitter 150 may be installed between the image-capture part 140 and the substrate 110. The beam splitter 150 reflects one part of the entered light and transmits the other part. Therefore, the light provided from the illumination part 130, one part of the light provided from the illumination part 130 is reflect to the substrate 110 and the other part is transmitted by the beam splitter 150. In addition, one part of the light that is reflected from the substrate 110 transmits the beam splitter 150 to enter the image-capture part 140, and other part is reflected by the beam splitter 150. Therefore, a scattered light is provided to the measurement object 112 by using the beam splitter 150, and by using a coaxial lighting system a light that is reflected from the measurement object 112 goes through the beam splitter 150 that allows a light reflected from the measurement object 112 to re-enter the image-capture part 140 through the beam splitter 150, a measurement credibility may be improved, in cases such as a measurement object 112 having high surface reflection or a shadow that is generated from a surrounding object.

Measuring the measurement object 112 formed on the substrate 110 by using the substrate inspection apparatus 100 having the above-described structure, when a telecentric lens is used as the imaging lens 144 installed in the image-capture part 140, since a tilt pose of the substrate 110 may not be estimated, a distortion may occur in a measurement data according to a tilt pose of the substrate 110 that is set on the stage 160. Therefore, in order to acquire an accurate measurement data of the measurement object 112, the measurement data according to the tilt pose of the substrate 110 needs to be compensated. The method of compensating the distortion of the measurement object according to the tilt pose of the substrate is described more fully hereinafter.

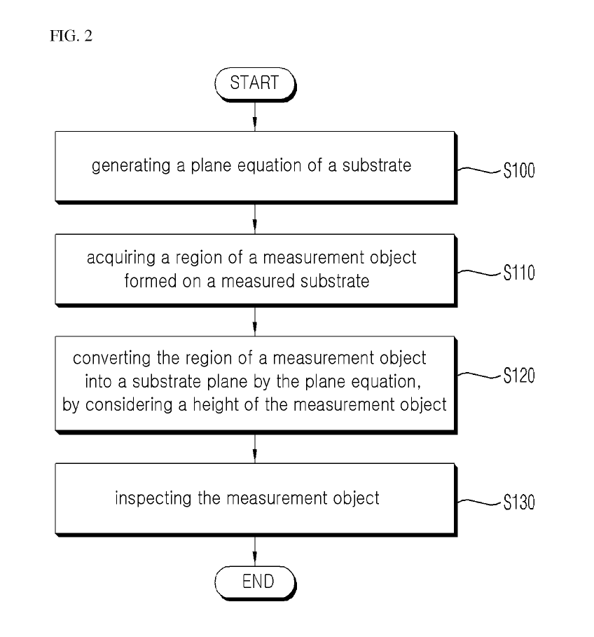

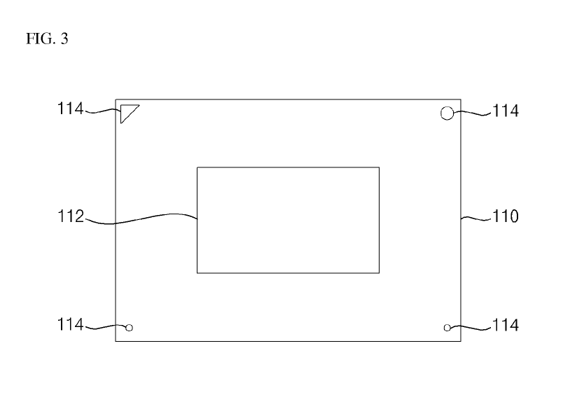

FIG. 2 is a flow chart illustrating a compensation method of a measurement object according to an embodiment of the present invention. FIG. 3 is a plan view illustrating a substrate, on which a measurement object is formed.

Referring to FIG. 2 and FIG. 3, in order to compensate a distortion according to a tilt pose of the measurement object 112, first a plane equation of the substrate 110 by measuring the substrate 110, on which the measurement object 112 is formed, with the image-capture part 140, is generated in step S100. The plane equation of the substrate 110 may acquire a location of a three randomly selected points of the substrate 110 by measuring the three randomly selected points of the substrate 110. For example, a location of a plurality of indication marks 114 formed on the substrate 110 are measured to generate the plane equation of the substrate 110. In other words, the indication mark 114 is formed on four corners of the substrate 110, and the plane equation is generated by using a measurement data of at least three of the four indication marks 114.

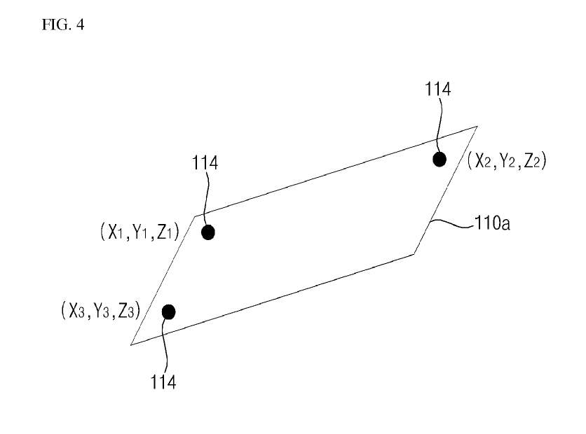

FIG. 4 is a drawing illustrating a substrate plane by a plane equation.

Referring to FIG. 1 and FIG. 4, in order to generate the plane equation by using at least three of the indication marks 114, an X, Y, Z coordinate of the indication marks 114 are required. The X, Y coordinate of the indication marks 114 may be easily acquired by using a measurement image measured by the image-capture part 140 through a light provided from the illuminating part 130. On the other hand, the Z coordinate of the indication marks 114 may be acquired by a different method than the measurement of the X, Y coordinate. In one example, the Z coordinate of the indication marks 114 may be acquired by measuring a distance between the indication marks 114. In other words, the distance between the measured indication marks 114 and a distance between the known indication marks 114 are compared to calculate a tilted angle, to acquire a height values (Z1, Z2, Z3) of the indication marks. In other example, the Z coordinate of the indication marks 114 may be acquired by using a laser (not shown). In other words, the laser is provided to each indication mark 114 with a laser source and a laser reflected from the indication mark is measured, to acquire a height value (Z1, Z2, Z3) of the indication mark. In another example, the Z coordinate of the indication marks 114 may be acquired by measuring the substrate with a moire measurement technique. In other words, a plurality of pattern-images acquired by providing a pattern-light from the plurality of projection parts 130 is image-captured through the image-capture part 140, to acquire a height value (Z1, Z2, Z3) of the indication mark.

A plane equation is generated by using the at least three indication marks 114 or an X, Y, Z coordinate of random points on the plane, and the plane equation is used to acquire a substrate plane 110a corresponding to the substrate 110 that is set on the stage 160, in order to identify a tilt pose of the substrate.

Referring to FIG. 1 and FIG. 2, acquiring a region of a measurement object formed on a measured substrate in step 110 is performed separately from the acquiring the plane equation of the substrate 110. For example, an image that is captured from the image-capture part 140 by providing a light from the illuminating part 130 may be used to acquire a coordinate of a corner and a center of the measurement object 112.

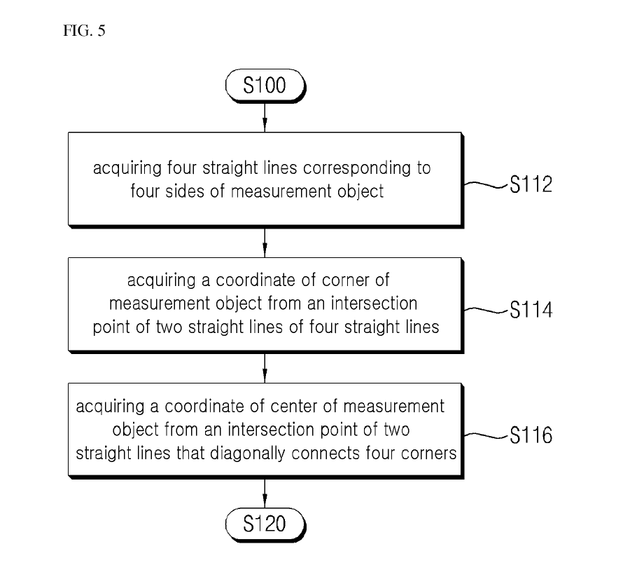

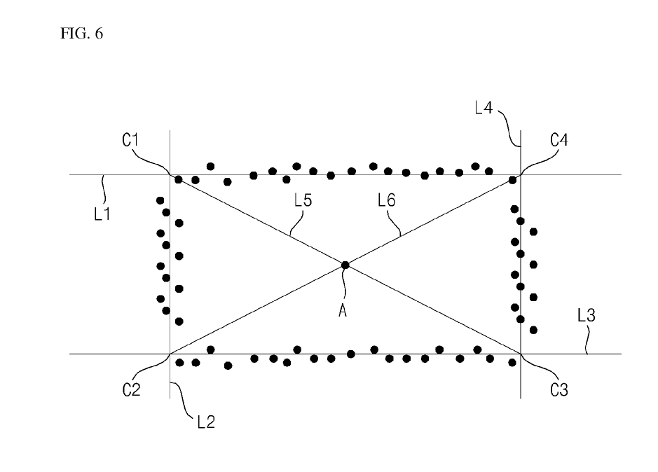

FIG. 5 is a flow chart illustrating a method of acquiring a region of measurement object. FIG. 6 is a conceptual view illustrating a method of acquiring a region of measurement object.

Referring to FIG. 5 and FIG. 6, in order to a acquire a region of the measurement object 112, four straight lines (L1,L2, L3, L4) corresponding to four sides of the measurement object 112 so that two facing sides of the four sides are maintained parallel, are acquired in step 112. For example, a distribution map of the pixels corresponding to the four side of the measurement object 112 obtained from an intensity information of an image captured from the image-capture part 140 is used to acquire to the four straight lines (L1, L2, L3, L4) corresponding to each side.

Then, coordinates of a corner (C1, C2, C3, C4) of the measurement object 112 are acquired from an intersection point of a two straight lines of the four straight lines (L1, L2, L3, L4) in step S114. For example, a coordinate of the first corner (C1) is acquired from an intersection point between the first straight line (L1) and the second straight line (L2), a coordinate of the second corner (C2) is acquired from an intersection point between the second straight line (L2) and the third straight line (L3), a coordinate of the third corner (C3) is acquired from an intersection point between the first straight line (L3) and the second straight line (L4), and a coordinate of the fourth corner (C4) is acquired from an intersection point between the fourth straight line (L4) and the first straight line (L1).

Then, a coordinate of a center (A) of the measurement object 112 is acquired from an intersection point of two straight lines (L5, L6) that diagonally connects four corners (C1, C2, C3, C4) in step S116. In other words, an intersection point of the fifth straight line (L5) that connects the first corner (C1) and the third corner (C3) located diagonally to each other and the sixth straight line (L6) that connects the second corner (C2) and the fourth corner (C4) located diagonally to each other, is used acquire a coordinate of a center (A) of the measurement object 112. Therefore, corners (C1, C2, C3, C4) of the measurement object 112 and the coordinate of the center (A) are acquired to acquire the region of the measurement object 112. Meanwhile, a center of the substrate 110 may also be acquired from the method of acquiring the center (A) of the measurement object 112.

Referring to FIG. 2 and FIG. 6, the region of a measurement object 112 acquired by the measurement of the measurement object 112 is converted into a substrate plane by the plane equation 110a, by considering a height of the measurement object in step S120.

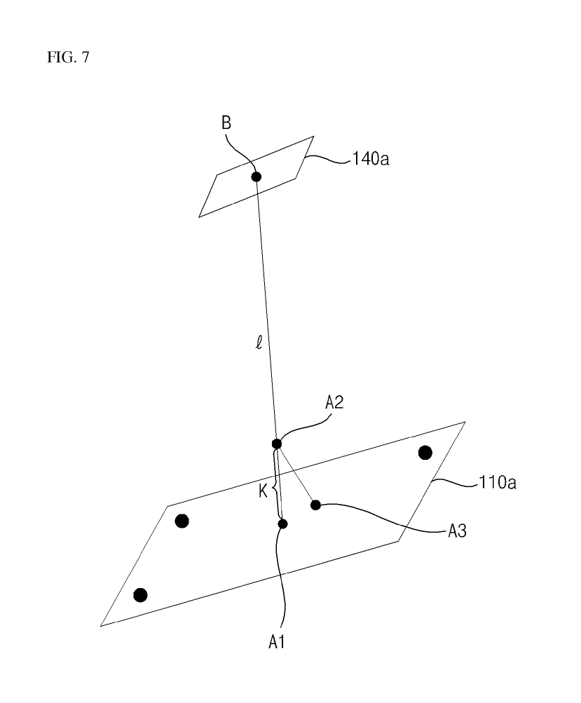

FIG. 7 is a conceptual view illustrating a process of correcting a region of measurement object into a substrate plane by plane equation.

Referring to FIG. 7, the region of the measurement object 112, i.e. the corner and the center coordinate of the measurement object is acquired, and is converted into the substrate plane by the plane equation 110a. A reference of the region of the measurement object 112 used for inspection should be a lower face of the measurement object 112 that contacts with the substrate 110, however, in reality, the region of the measurement object 112 measured is a upper face of the measurement object 112 seen from the image-capture part 140. Therefore, when the measurement object having a predetermined height is tilted, due to the height of the measurement object 112 a deviation of a region location between the upper face and the lower face may occur, so correcting the region of the measurement object 112 projected to the substrate plane 110a by considering the height of the measurement object 112 is necessary.

In order to correct the region of the measurement object 112 projected to the substrate plane 110a, one point A3 on the substrate plane with regard to at least one location (for example, a center point) of the region of the measurement object 112 is acquired, wherein a vertical distance from a point A2 on a straight line 1 connecting the image plane 140a of the image-capture part 140 and the substrate plane 110a by the plane equation to the one point A3 on the substrate plane 110a corresponds to the height k of the measurement object. The point A2 on the straight line 1 is a point of the upper face of the measurement object 112. The point A3 on the substrate plane 110a is a point of the lower face of the measurement object 112. By applying the center and the corner of the measurement object 112 to the above-described process, the region of the measurement object 112 may be converted into the substrate plane 110a by the plane equation.

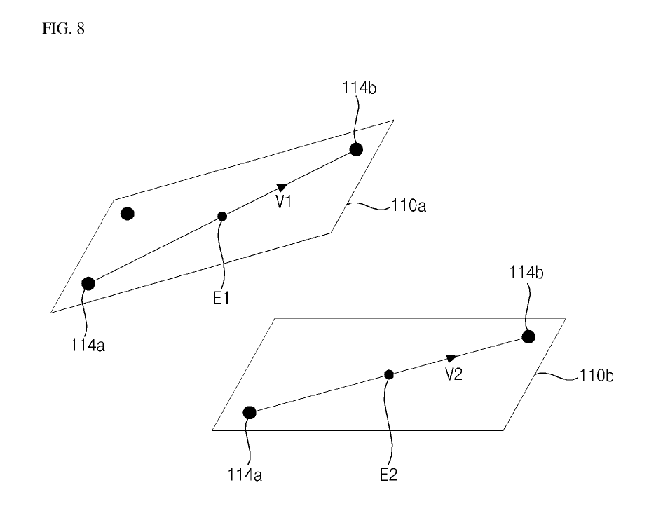

FIG. 8 is a conceptual view illustrating a process of matching a substrate plane by plane equation and a substrate plane by reference data.

Referring to FIG. 2 and FIG. 8, after converting the region of the measurement object 112 into the substrate plane 110a by the plane equation, the substrate plane 110a by the plane equation and a substrate plane 110b by the reference data. The reference data may be a CAD data having basic information of the substrate 110. In addition, the reference data may be a design data or a manufacturing data for manufacturing a printed circuit board (PCB), a gerber data, a PCB design file, or a data extracted from the PCB design file having standard or non-standard type (for example, ODB++ or a file that is extracted from cad design tool), in addition, an information acquired from an image file that is obtained from a bare board or a populated board with a video camera, may be used. The reference data includes a location information of the measurement object 112, the indication mark 114, etc. formed on the substrate 110.

In order to match the substrate plane 110a by the plane equation and the substrate plane 110b by the reference data. For example, a first middle point El on a line that connects the first indication mark 114a and the second indication mark 114b according to the substrate plane 110a by the plane equation, and a second middle point E2 on a line that connects the first indication mark 114a and the second indication mark 114b according to the substrate plane 110b by the reference data, are measured, and the first middle point E1 and the second middle point E2 are matched.

Then, the line that connects the first indication mark 114a and the second indication mark 114b according to the substrate plane 110a by the plane equation and the line that connects the first indication mark 114a and the second indication mark 114b according to the substrate plane 110b by the reference data, are matched. In other words, vectors (V1, V2) are made corresponding to lines that connect centers El and E2 of the indication marks with the indication marks for each substrate plane 110a and 110b, end points of the two vectors (V1, V2) are matched, to thereby match the substrate plane 110a by the plane equation and the substrate plane 110b by the reference data.

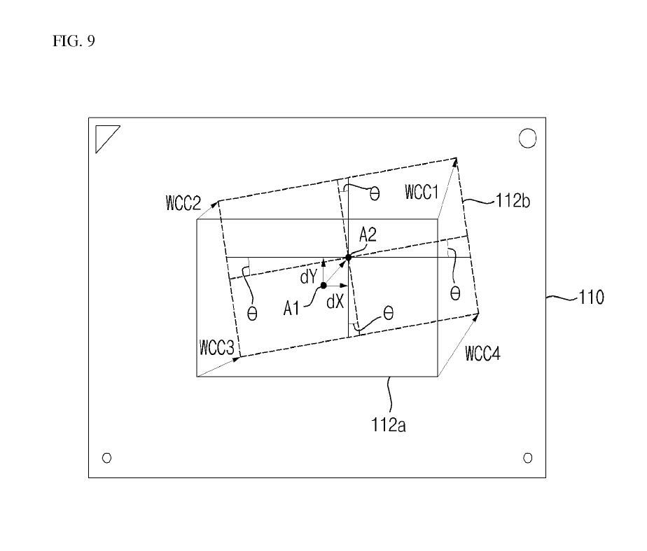

FIG. 9 is a conceptual view illustrating a process of inspecting a measurement object.

Referring to FIG. 2 and FIG. 9, after matching the substrate plane 110a by the plane equation and the substrate plane 110b by the reference data, the measurement object 112 is inspected based on the region of the measurement object 112 by the reference data and the region of a measurement object 112b converted into the substrate plane 110a by the plane equation. A transform between a coordinate of the measurement object 112a and a coordinate of the measurement object 112b are calculated, to calculate an offset value of the measurement object 112b on the plane equation, in order words, the measurement object 112b on the measurement data.

The offset value of the measurement object 112b is a value showing how much the pose of the measurement object 112 from the measured data is tilted compared to the measurement object 112a from the reference data, and may include at least one of a first offset dX corresponding to an offset in an X direction, a second offset dY corresponding to an offset in a Y direction, a third offset e corresponding to a tilted angle, and a fourth offset WCC corresponding to a distance between corner. The first offset dX is a distance difference in a X direction between a center Al of the measurement object 112a by the reference data and a center A2 of the measurement object 112b by the plane equation. The second offset dX is a distance difference in a Y direction between a center A1 of the measurement object 112a by the reference data and a center A2 of the measurement object 112b by the plane equation. The third offset e is a tilted angle of the measurement object 112a by the reference data to the measurement object 112b by the plane equation. The fourth off set WCC is a distance between four corners of the measurement object 112a by the reference data and four corners of the measurement object 112b by the plane equation. For example, the fourth offset WCC may be the one with the highest distance value of WCC1, WCC2, WCC3, WCC4 in FIG. 9.

Therefore, the region error caused by the tilted angle between the measurement substrate plane and the image plane of the image-capture part of the measurement data and the height of the measurement object caused by the tilted angle of the measurement substrate plane the height of is corrected, and the measurement object is inspected based on the corrected measurement data, in order to improve credibility and accuracy of the measurement data

Meanwhile, in a substrate inspection apparatus using a moire measurement system, a height of a measurement object 112 is measured based on a reference plane that is saved in the apparatus. However, a distortion may occur when a relative reference plane is relatively tilted to an image plane of the image-capture part 140, so before measuring the height of a measurement object, a new setting of an actual reference plane of the apparatus is necessary. In other words, acquiring a relative error between an ideal reference plane that is parallel with an image plane of the image-capture part and a measured reference plane, to use the error value as a compensating data.

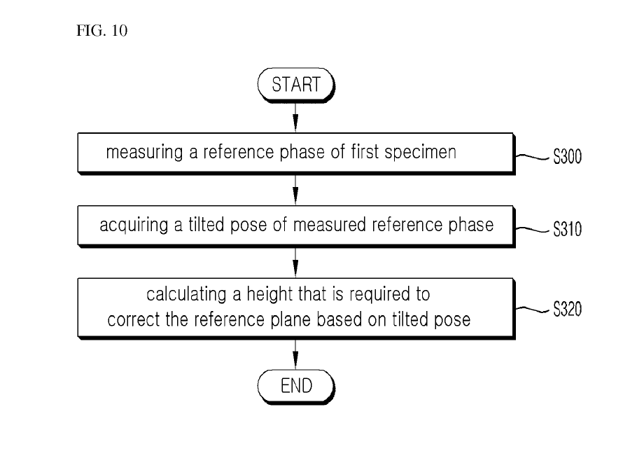

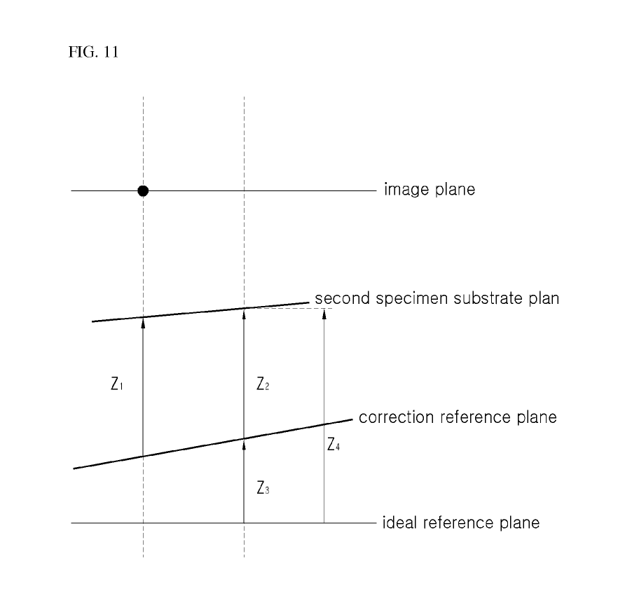

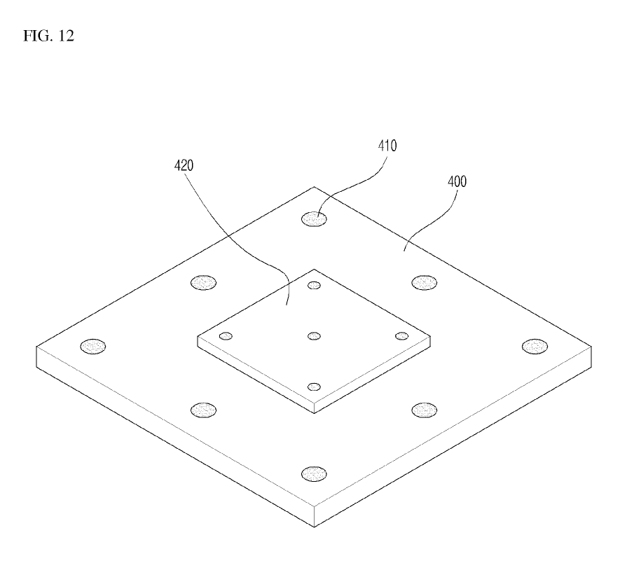

FIG. 10 is a flow chart illustrating a correction method of a substrate plane according to an embodiment of the present invention. FIG. 11 is a conceptual view illustrating a correction method of a substrate plane in FIG. 10. FIG. 12 is a perspective view illustrating a second specimen in FIG. 10.

Referring to FIG. 1, FIG. 10, FIG. 11 and FIG. 12, in order to correct the reference plane, a substrate for measuring the reference phase (first specimen) is set at a measurement region of the image-capture part 140, then a reference phase of the substrate for measuring the reference phase is measured in step S300. For example, a phase of the substrate for measuring the reference phase is measured through a phase measurement profilometry (PMP) by using the projection part 120.

Then, a tilted pose of a reference plane of the measured reference phase to an image plane of the image-capture part is acquired in step S310.

To acquire the tilted pose of the measured reference phase, a substrate for measuring pose information (second specimen) is set at a measurement region of the image-capture part 140, then the substrate for measuring pose information is measured from the image-capture part 140 to acquire a substrate plane of the substrate for measuring pose information. For example, the substrate for measuring pose information may be a substrate 400 having a plurality of indication marks 410 to verify a tilted pose as in FIG. 8.

The substrate plane of substrate for measuring pose information measures a distance between an indication marks 410 formed on a substrate for measuring pose information, and by using thereof a tilted pose of the substrate 400 for measuring pose information may be calculated. For example, X and Y axis of the indication marks 410 are acquired from an image-captured measured image being image-captured by an image-capture part 140 that has a light provided from a illumination part 130, and Z axis of the indication marks 410 is acquired by measuring a distance between the indication marks 410. In other words, a distance between the measured indication marks 410 and a distance between the indication marks 410 that is known from the reference data (for example, a CAD data) are compared to calculate a tilted slope, to acquire a relative height of the indication marks 410. Meanwhile, the substrate 400 for measuring a pose information may include a protrusion part 420 that protrudes a predetermined height from a central part to determine whether a slope of the substrate is positive or negative. Since a shape of the protrusion part 420 that is image-captured from the image-capture part 140, changes by a positive or negative of a slope of the substrate 400 for measuring a pose information, by using a measurement image of the protrusion part 420 the tilted slope of the substrate for measuring pose information may be determined positive or negative.

Therefore, a plane equation is generated by using the acquired tilted pose of a substrate 400 for measuring pose information, a substrate plane of the substrate 400 for measuring pose information is acquired by using the plane equation, then a tilted pose of the substrate 400 for measuring pose information to the image plane and a height from an reference plane (Z₄) are acquired.

Meanwhile, the ideal reference plane is a predetermined plane that is parallel with the image plane, for example, one of a height value from the measured indication marks 410 may be used.

In different, a substrate plane of the substrate 400 for measuring pose information may be known by using the plan equation showing a tilted pose of a substrate 400 for measuring pose information, for example, the plane equation may be acquired from measuring a random location of a three spot on a substrate 400, for example, a Z axis of at least three indication marks 410 may be acquired by laser (not shown).

The acquired X,Y, and Z axis of at least three of the indication marks 410 may be used to generate a plane equation, by using the plane equation a substrate plane of a substrate 400 for measuring pose information is obtained, then a tilted pose of a substrate 400 for measuring pose information against an ideal reference plane being parallel with an image plane and a height (Z₄) from the ideal reference plane may be acquired.

Then, after a phase of the substrate 400 for measuring pose information is measured to acquire a height (Z₁, Z₂) based on the reference phase. The phase of the substrate 400 for measuring pose information may be measured through a phase measurement profilometry (PMP) by using a projection part 120.

Then, after a tilted pose of the measured reference plane of the reference phase is acquired by comparing the reference plane of the substrate 400 for measuring pose information and the height of the substrate 400 for measuring pose information. For example, a height of a reference plane (Z₄) of a substrate 400 for measuring pose information is calculated from the predetermined ideal reference plane being parallel with an image plane of the image-capture part 140, and based on the height of a reference plane (Z₄) and the substrate 400 for measuring pose information, the tilted pose of the reference plane of the reference phase is acquired.

Then, a height (Z₃) that needs correction to the image-capture part 140 is calculated based on the tilted pose of the reference plane of the reference phase as in step S320. For example, the height (Z₄) of the reference plane of substrate 400 for measuring pose information from the ideal reference plane and the height (Z₂) of the substrate 400 for measuring pose information acquired from a PMP measurement is subtracted to acquire a height (Z₃) that is needed to correct the reference plane, then a pose of the correction reference plane that applies to the real reference plane may be known.

In an example, the height (Z₃) that is needed to correct the reference plane may be able to know each of the projection parts.

Meanwhile, the substrate for measuring reference phase (first specimen) and the substrate for measuring pose information (second specimen) may be physically formed as an individual substrate, in different, the function for measuring reference phase and the function for measuring pose information may be included in one substrate.

Therefore, before measuring the height of the measurement object 112, by correcting the reference plane that is a reference of height measurement, a measurement accuracy may be more improved.

Meanwhile, while inspecting the substrate 110 having the measurement object 112, a distortion of the inspection data may occur due to an optical system itself having a distortion of the optical system that is installed in the substrate inspection apparatus 100. Therefore, before measuring the measurement object 112, by correcting a systematic distortion of the substrate inspection apparatus 100, a credibility of the measurement data may be improved.

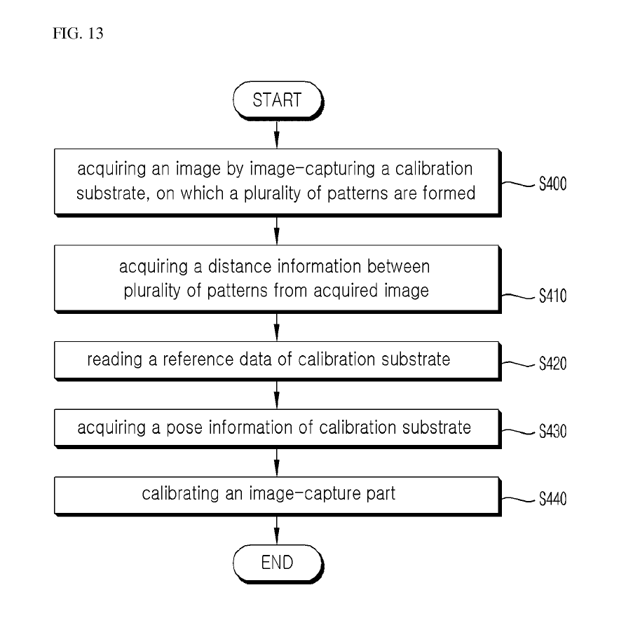

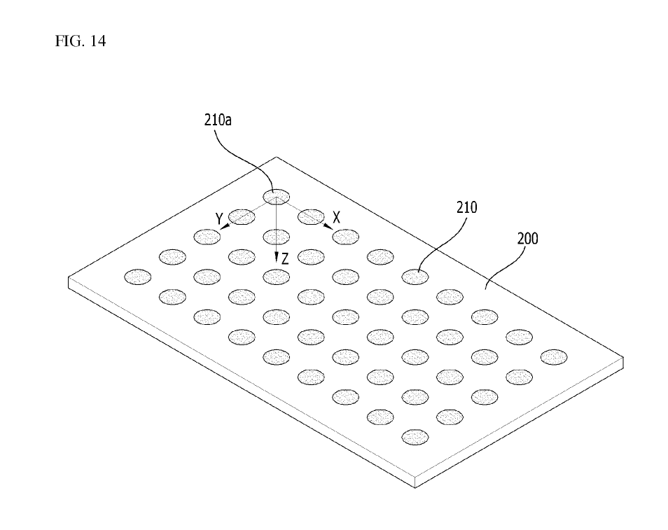

FIG. 13 is a flow chart illustrating a method of calibrating an image-capture part in FIG.1. FIG. 14 is a perspective view illustrating a calibration substrate.

Referring to FIG. 1, FIG. 13, and FIG. 14, a calibration method of the image-capture part 140, measures a distance between a plurality of patterns that are formed on a calibration substrate 200, and calibrates the image-capture part based on a distance information between the plurality of patterns from a reference data of the calibration substrate 200 and the measured distance information between the plurality of patterns 210.

In this case, the calibration substrate 200 and an image plane of the image-capture part may be tilted not being parallel. Therefore, it is necessary to correct an error of the distance information of the plurality of patterns 210 caused by the tilted pose of the image plane and the calibration substrate 200.

In order to correct the error caused by the tilt of the calibration substrate 200, the image-capture part 140 having the camera 142 and the image-capture lens 144 image-captures the calibration substrate 200, on which a plurality of patterns are formed, to acquire an image in step S400. In this case, the image-capture lens 144 may include a sphere lens, for example, the sphere lens may include a telecentric lens that only passes a light that is parallel with the light axis, in order to minimize an image distortion caused by a Z axis.

Then, a distance information between the plurality of patterns 210 from the acquired image by using the image-capture part is acquired in step S410. For example, one pattern 210a of the plurality of patterns 210 is used as a reference to calculate a X axis or a Y axis of separate distance from the other patterns, in order to acquire the distance information between the plurality of patterns 200. .

Meanwhile, beside acquiring the distance information between the plurality patterns 210 from the acquired image by using the image-capture part 140, the substrate inspection apparatus 100 may also read a reference data (for example, a CAD data) of the calibration substrate 200 in step S420. The reference data includes a distance information between the plurality of patterns 210.

Then, a pose information showing a tilted pose of the calibration substrate 200 is acquired by using the distance information between the plurality of patterns 210 acquired from the image-capture part 140 and a corresponding of the distance information between the plurality of patterns 210 from the reference data in step S430. The tilted pose of the calibration substrate 200 is a relative pose to an image plane of the image-capture part 140. For example, the distance information between the plurality of patterns 210 measured by using the image-capture part 140 and the distance information between the known plurality of patterns 210 from the reference data (for example, a CAD data) of the calibration substrate 200 are compared to calculate a tilted angle of the calibration substrate 200.

Meanwhile, various shapes of the calibration substrate 200 may be measured at least twice and by using an average value of the measured distances the image-capture part 140 may be calibrated. In other words, a pose and a position of the calibration substrate 200 may be changed to acquire the distance information between the plurality of patterns 210, then by comparing the distance information between the plurality of patterns 210 and the reference data of the calibration substrate 200 that relates to the distance information between the plurality of patterns 210, a relatively tilted angle between a substrate plane of the calibration substrate 200 and the image plane of the image-capture part 140 may be calculated based on at least one of a pose information that has a lowest error between the compared results or an average pose information between the compared results.

Meanwhile, while acquiring the pose information of the calibration substrate 200, at least two patterns of the patterns 210 that is measured by using the image-capture part 140 are compared, to determine whether a slope of the calibration substrate 200 is positive or negative. It is preferred to compare sizes between two patterns that are relatively far away in a diagonally direction.

Then, the image-capture part 140 is calibrated by using the pose information of the calibration substrate 200 and the known reference data of the calibration substrate 200 in step S440. For example, the pose information and the reference data is substituted to an image-capture part matrix equation mathematically defining characteristic of the image-capture part 140, and thus, a calibration data such as a focal distance information and/or a scale information, etc. of the image-capture part 140, which corresponds to an unknown. In this case, in order to improve an accuracy of the calibration data, an average value of calibration data that is acquired by measuring at least two poses of the calibration substrate 200 may be used to perform a calibration of the image-capture part 140.

Therefore, a calibration of the image-capture part 140 is performed by considering the pose information of the calibration substrate 200 and is used to measure the measurement object to improve a measurement accuracy.

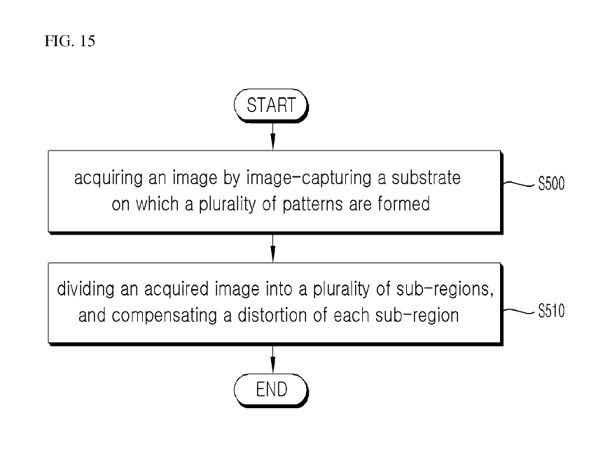

FIG. 15 is a flow chart illustrating a correction method of a non-spherical lens formed on a substrate inspection apparatus.

Referring to FIG. 1 to FIG. 15, the substrate inspection apparatus 100 according to an exemplary embodiment of the present invention measures a three-dimensional shape of the measurement object by using an optical system that includes the image-capture lens 144 (for example, a telecentric lens), disposed in the image-capture part 140, and the beam splitter 150 installed below the image-capture part (the beam splitter is a kind of a non-sphere lens).

In this case, due to the optical system itself having non-uniformity, a distortion may occur to the image-captured image. Therefore, compensating a distortion caused by the optical system is necessary.

Meanwhile, the optical system may include a sphere lens and a non-sphere lens, an error caused by the sphere lens may generally have a regular distortion and a non-sphere lens may have an irregular distortion. Therefore, when an error of the optical system is compensated, an entire distortion of the sphere lens and the non-sphere lens may be compensated or each of the error of the sphere lens and the non-sphere lens may be compensated.

The substrate inspection apparatus of an exemplary embodiment of the present invention, the image-capture lens 144 includes a sphere lens, however, a non-uniformity of the sphere lens may cause a distortion of an image-captured image. Therefore, before measuring the measurement object 112, an optical system installed in the substrate inspection apparatus 100 is corrected to compensate an distortion caused by a non-uniformity of the image-capture lens 144 having the sphere lens. The compensation method of the sphere lens is a general technique, so further description of the method is omitted.

Meanwhile, the distortion caused by a non-sphere lens installed in the substrate inspection apparatus 100 needs to be compensated. For example, the non-sphere lens may be a beam splitter 150. The beam splitter 150 is formed as a plate-shape and both sides have a coating layer. A refractive index of the beam-splitter 150 may be different according to region causing a distortion of an image-captured image.

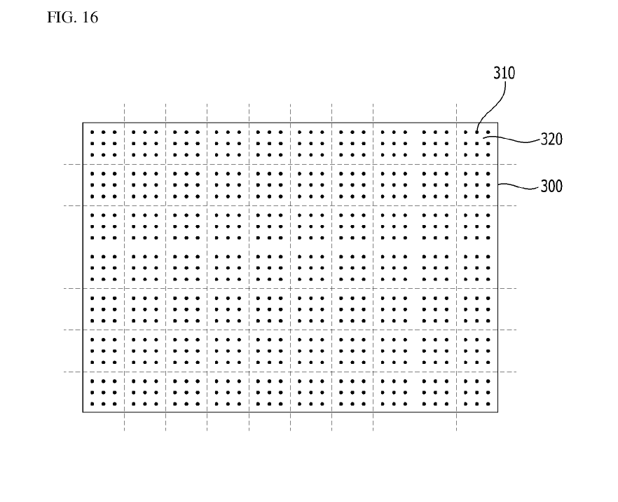

FIG. 16 is a conceptual view illustrating a method of correcting a distortion caused by a non-spherical lens.

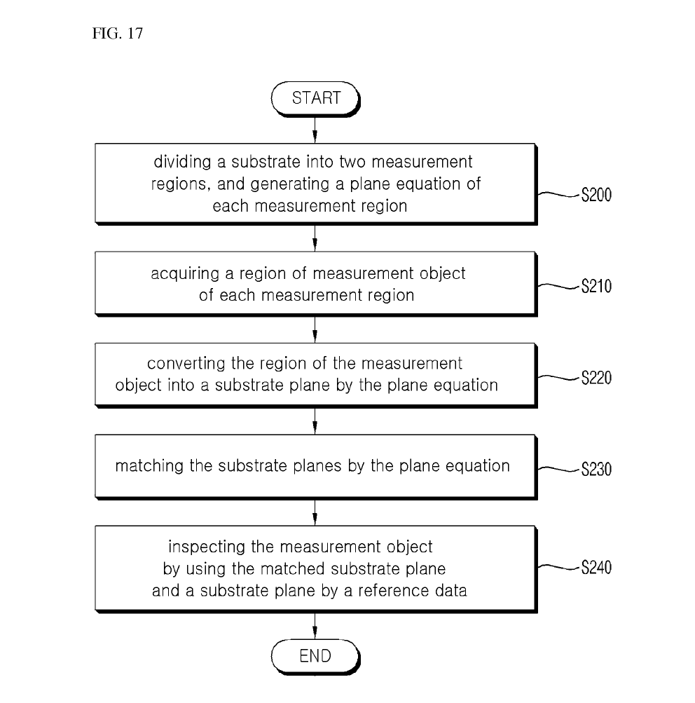

Referring to FIG. 1, FIG. 15, and FIG. 17, in order to compensate an error caused by the non-uniformity of the non-sphere lens, a substrate 300, on which a plurality of patterns 310 are formed, is image-captured with the image-capture part 140 to acquire an image of the substrate 300 in step S500. After, the image-captured image of the substrate 300 by using the image-capture part 140 is divided into a plurality of sub-regions 320, and each of the sub-regions 320 are applied with a different compensating condition to compensate a distortion in step S510. For example, an image of the substrate 300 may be divided into sub-regions 320 having lattice-shape.

The compensating condition applied to each of the sub-regions 320 may be specialized to the sub-region 320 by using a pattern compensation values that corresponding to each of the patterns included in the sub-region 320. For example, a location of the patterns 310 in the reference data (for example, a CAD data) of the substrate 300 and a location of the patterns of the image-captured image are compared to calculate an error value (in other words, a compensation value) between the patterns 310, then a compensating condition is set by calculating a value that has minimized error of the pattern compensating value of the pattern 310 in the each of sub-regions 320, or an average value between the pattern compensating value.

Meanwhile, after compensating a distortion of each sub-region by a plurality of times while changing a shape of the sub-region, the shape of the sub-region 320 may be decided based on the acquired compensation data. For example, while changing sizes of the lattice-shaped sub-region 320 to small or large, specialized compensating condition of different sizes of the sub-region 320 are applied, and based on the result a sub-region shape having the least distortion value is selected, to optimize the sub-region 320.

In addition, compensating a distortion of the sub-region 320, by using the pose information acquired during the calibration of the image-capture part 140 of FIG. 13 and FIG. 14, a more accurate distortion compensation of the non-sphere lens may be performed.

Therefore, the distortion caused by the non-uniformity of the optical system of the image-capture part 140 and the beam splitter 150 installed in the substrate inspection apparatus, is compensated before a real measurement, so a measurement credibility may be improved.

Meanwhile, when an entire region of a large substrate may not fit in the field of view (FOV) of the image-capture part 140, an additional process beside from the above-method is necessary.

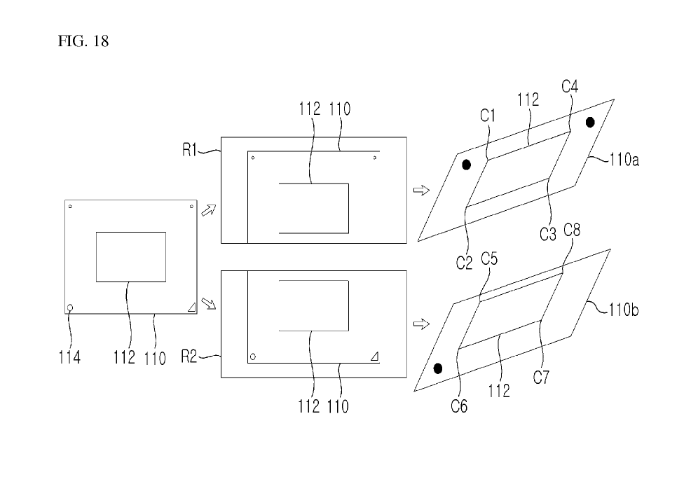

FIG. 17 is a flow chart illustrating a compensation method of a measurement object according to another embodiment of the present invention. FIG. 18 is a conceptual view illustrating a process of measuring an offset value of a large size substrate.

Referring to FIG. 1, FIG. 17, and FIG. 18, when the image-capture part 140 may not capture the entire region of the large-size substrate 100, on which a measurement object is formed 112, the substrate 110 is divided into at least two measurement regions, and a plane equation of each measurement region is generated in step 5200. For example, the substrate 110 is divided into first measurement region R1 and second measurement region R2, and each measurement region are measured, then two plane equation according to each measurement region are generated. The entire region of the measurement object 112 may be included in the first measurement region R1 and the second measurement region R2. Meanwhile, a method of generating the plane equation of each of the measurement region R1, R2 is described in FIG. 4, so further description of the method is omitted. Therefore, a substrate plane 110a, 110b of the substrate 100 of each measurement region R1, R2 may be acquired by using the generated two plane equation.

Then, a region of the measurement object 112 of the each measurement region R1, R2 are acquired in step S210. The region of the measurement object, in other words, a method of acquiring coordinate of a corner and a center is described in FIG. 5 and FIG. 6, so further description of the method is omitted.

Then, the region of the measurement object 112, in other words, coordinate of the corner and the center, acquired from the measurement regions R1, R2 is converted into a substrate plane 110a, 110b by the plane equation. The method of converting the region of the measurement 112 into the substrate planes 110a, 110b is described in FIG. 7, so further description of the method is omitted.

Then, the substrate planes 110a, 110b by the plane equation acquired from a plurality of measurement region are matched into an identical plane in step S230. During matching the substrate planes 100a, 100b, at least one of a common region of each measurement region R1, R2 and the region of the measurement region may be used as a reference. For example, coordinates of four corners C1, C2, C3, C4 of the measurement object 112 on the acquired substrate plane 100a from the first region R1 and coordinates of four corners C5, C6, C7, C8 of the measurement object 112 on the acquired substrate plane 100b from the second region R2, are matched to form one substrate plane.

Then, the substrate plane matched into an identical substrate plane and the substrate plane by the reference data, may be matched. The method of matching the substrate plane matched into an identical substrate plane and the substrate plane by the reference data is described in FIG. 8, so further description of the method is omitted.

Then, the measurement object 112 is measured based on the region of the measurement object 112 according to the substrate plane matched into an identical substrate plane and the region of the measurement object 112 according to the substrate plane by the reference data in step S240. The inspection method of the measurement object 112 is described in FIG. 9, so further description of the method is omitted.

Therefore, when the image-capture part 140 may not capture the entire region of the large-size substrate, on which a measurement object is formed 112, the substrate is divided into two measurement regions, and each measurement region are measured, and generating one substrate plane by matching the measured substrate plane to the region of the measurement object, in order to accurately perform an inspection of a measurement object on a large-size substrate.

The detailed description of the present invention is described with regard to the preferable embodiment of the present invention, however, a person skilled in the art may amend or modify the present invention within the spirit or scope in the following claim of the present invention. Therefore, the detailed description described above and the drawing illustrated hereinafter does not limit the technical idea of the invention.

1. A method of inspecting a substrate, comprising:
generating a plane equation of a substrate by measuring the substrate, on which a measurement object is formed, with an image-capture part;
acquiring a region of the measurement object formed on the measured substrate;
converting the region of the measurement object into a substrate plane by the plane equation, by considering a height of the measurement object; and
inspecting the measurement object based on the region of the measurement object converted into the substrate plane by the plane equation and a region of the measurement object by a reference data.

2. The method of inspecting a substrate of claim 1, wherein generating a plane equation, comprises:
generating the plane equation by measuring a distance between an indication marks that are formed on the substrate.

3. The method of inspecting a substrate of claim 1, wherein generating a plane equation, comprises:
generating the plane equation by measuring the substrate with a laser.

4. The method of inspecting a substrate of claim 1, wherein generating a plane equation, comprises:
generating the plane equation by measuring the substrate with a moire measurement technique.

5. The method of inspecting a substrate of claim 1, wherein acquiring a region of the measurement object, comprises:
acquiring four straight lines corresponding to four sides of the measurement object so that two facing sides of the four sides are maintained parallel.

6. The method of inspecting a substrate of claim 1, wherein converting the region of the measurement object into the substrate plane by the plane equation by considering a height of the measurement object, comprises:
converting the region of the measurement object into the substrate plane by the plane equation by acquiring one point on the substrate plane with regard to at least one location of the region of the measurement object, wherein a vertical distance from a point on a straight line connecting the image plane of the image-capture part and the substrate plane by the plane equation to the one point on the substrate plane corresponds to the height of the measurement object.

7. The method of inspecting a substrate of claim 1, further comprising:
matching a middle of a line that connects the indication mark of the substrate plane by the reference data with a middle of a line that connects the indication mark of the substrate plane by the plane equation; and
matching the line that connects the indication mark of the substrate plane by the reference data with the line that connects the indication mark of the substrate plane by the plane equation.

8. The method of inspecting a substrate of claim 1, wherein the inspection of the measurement object measures at least one of four offsets, the four offsets comprising:
a first offset corresponding to an offset in an X direction between a center of the measurement object by the reference data and a center of the measurement object by the plane equation;
a second offset corresponding to an offset in a Y direction between a center of the measurement object by the reference data a center of the measurement object by the plane equation;
a third offset corresponding to a tilted angle of the measurement object by the plane equation to the measurement object by the reference data; and
a fourth offset corresponding to a distance between four corners of the measurement object by the reference data and four corners of the measurement object by the plane equation.

9. The method of inspecting a substrate of claim 1, wherein the substrate is measured by using an image-capture part having a telecentric lens.

10. The method of inspecting a substrate of claim 1, before measuring the substrate on which a measurement object is formed, further comprising:
correcting the reference plane that is a reference of a height measuring.

11. A method of inspecting a substrate comprising:
generating a plane equation of a substrate by measuring the substrate, on which a measurement object is formed;
acquiring a region of the measurement object formed on the substrate;
converting the region of the measurement object into a substrate plane by the plane equation;
matching the substrate plane by the plane equation with a substrate plane by a reference data; and
inspecting the measurement object based on a region of the measurement object by the reference data and the region of the measurement object converted into the substrate plane by the plane equation.

12. A method of inspecting a substrate comprising:
generating a plane equation of a substrate for each measurement region, by dividing an entire portion of the substrate, on which a measurement object is formed, into at least two measurement regions and measuring each measurement region, with an image-capture part;
acquiring a region of the measured measurement object of each measurement region;
converting the acquired region of the measured measurement object of each measurement region into a substrate plane by the plane equation;
matching a plurality of substrate planes by the plane equation acquired from a plurality of measurement regions with each other to an identical substrate plane; and
inspecting the measurement object based on the region of the measurement object by the substrate plane matched to the identical plane and a region of the measurement object by a reference data.

13. The method of inspecting a substrate of claim 12, wherein matching a plurality of substrate planes by the plane equation acquired from a plurality of measurement regions with each other to an identical substrate plane comprises:
matching the substrate planes based on at least one of a common region of the measurement regions and the region of the measurement object.

14. The method of inspecting a substrate of claim 12, wherein converting the acquired region of the measured measurement object of each measurement region into a substrate plane by the plane equation comprises:
converting the acquired region of the measured measurement object of each measurement region into a substrate plane by the plane equation, by considering a height of the measurement object.
